(19) United States
(12) Patent Application Publication
(10) Pub. No.: US 2026/0073846 A1
(43) Pub. Date: Mar. 12, 2026

(54) DATA DRIVER AND DISPLAY DEVICE INCLUDING THE SAME

(71) Applicant: LG Display Co., Ltd., Seoul (KR)

(72) Inventors: Seung Jin YOO, Paju-si (KR); Sang Jin NAM, Paju-si (KR); Hyun Gi HONG, Paju-si (KR)

(73) Assignee: LG Display Co., Ltd., Seoul (KR)

(21) Appl. No.: 19/227,200

(22) Filed: Jun. 3, 2025

(30) Foreign Application Priority Data
Sep. 12, 2024 (KR) 10-2024-0124520

(51) Int. Cl. G09G 3/32; G09G 3/3275

(52) U.S. Cl. CPC G09G 3/32; G09G 3/3275; G09G 2300/0842; G09G 2310/0275; G09G 2330/021

(57) ABSTRACT

A data driver according to an embodiment and a display device including the same are disclosed. The data driver includes an output circuit configured to output a pixel data as an image data voltage in analog form; a selection circuit configured to connect one of an output end of the output circuit and a wire to which a black data voltage is applied to a data line; and a control circuit configured to control the selection circuit so that the image data voltage and the black data voltage are alternately output at a predetermined time interval.

### CROSS-REFERENCE TO RELATED APPLICATION

This application claims priority to and the benefit of Korean Patent Application No. 10-2024-0124520, filed Sep. 12, 2024, the disclosure of which is incorporated herein by reference in its entirety.

### BACKGROUND

### Technical Field

The present disclosure relates to a data driver and a display device including the same.

### Description of the Related Art

Various flat panel display devices such as a liquid crystal display device, an electroluminescent display device, and the like are known. The electroluminescent display device may display an input image by emitting light by itself without a backlight by using the light-emitting elements disposed on each of the pixels. The light-emitting elements of the electroluminescent display device may be divided into an organic light-emitting element and an inorganic light-emitting element according to the material of the light-emitting layer.

Recently, a display device that uses a light-emitting diode (LED), an inorganic light-emitting element, as a light-emitting element of a pixel has attracted attention as a next-generation display device. Since LEDs are made of inorganic materials, they do not require a separate encapsulation layer to protect organic materials from moisture, and they are more reliable and have a longer lifespan than organic light-emitting diodes (OLEDs). In addition, LEDs have a fast lighting speed, excellent luminous efficiency, and impact resistance.

### BRIEF SUMMARY

The inventors recognized that a duty drive that drives the LEDs at a high current for a short time will improve the emission efficiency of LEDs.

In a method used to implement duty driving, the driving speed or driving frequency is increased to sequentially apply the image data voltage and then sequentially apply the black data voltage, during one frame period.

However, such driving method has a limitation in lowering the duty rate of the light-emitting element.

The present disclosure provides a data driver capable of lowering the duty rate of a light-emitting element and a display device including the same.

It should be noted that features of the present disclosure are not limited to the above-described features, and other features of the present disclosure will be apparent to those skilled in the art from the following descriptions.

A data driver according to embodiments of the present disclosure may include an output circuit configured to output a pixel data as an image data voltage in analog form; a selection circuit configured to connect one of an output end of the output circuit and a wire to which a black data voltage is applied to a data line; and a control circuit configured to control the selection circuit so that the image data voltage and the black data voltage are alternately output at a predetermined time interval.

A display device according to embodiments of the present disclosure may include a pixel array in which a plurality of data lines, a plurality of gate lines, and a plurality of pixels are arranged; a data driver configured to output a data voltage to the plurality of data lines; and a gate driver configured to output a gate signal to the plurality of gate lines; wherein the data driver comprises: an output circuit configured to output a pixel data as an image data voltage in analog form; a selection circuit configured to connect one of an output end of the output circuit and a wire to which a black data voltage is applied to a data line; and a control circuit configured to control the selection circuit so that the image data voltage and the black data voltage are alternately output at a predetermined time interval.

The present disclosure may lower the duty rate of the light-emitting element by alternately outputting the image data voltage and the black data voltage to the data lines at different timings at predetermined time intervals.

The present disclosure may lower the duty rate of the light-emitting element, thereby reducing power consumption and reducing the magnitude of the peak current.

The present disclosure may enable low-power operation because of its ability to reduce power consumption.

The effects of the present specification are not limited to the above-mentioned effects, and other effects that are not mentioned will be apparently understood by those skilled in the art from the following description and the appended claims.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to an embodiment of the present disclosure;

FIG. 2 is a diagram illustrating a pixel circuit according to an embodiment of the present disclosure;

FIG. 3 is a diagram illustrating a unit pixel structure according to an embodiment of the present disclosure;

FIG. 4 is a diagram illustrating the configuration of the data driver according to an embodiment of the present disclosure;

FIGS. 5A to 5C, FIGS. 6 to 8, and FIGS. 9A and 9B are drawings for explaining the data voltage output principle;

FIGS. 10 and 11 are drawings for explaining the data output principle according to the second embodiment of the present disclosure; and

FIGS. 12 and 13 are drawings for explaining the data output principle according to the third embodiment of the present disclosure.

### DETAILED DESCRIPTION

Advantages and features of the present specification and methods of achieving them will become apparent with reference to the example embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art, and the present specification includes the claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to,’ and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

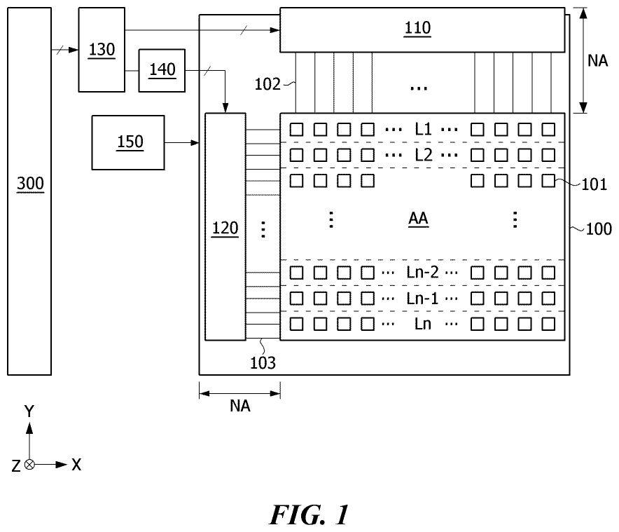

FIG. 1 is a block diagram illustrating a display device according to an embodiment of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The pixels may be arranged as real color pixels and pentile pixels. A pentile pixel may realize a higher resolution than a real color pixel by driving two sub-pixels with different colors as one pixel 101 and using a preset pixel rendering algorithm. This pixel rendering algorithm may compensate for insufficient color representation in each pixel with the color of light emitted from adjacent pixels.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 300 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data may include mode selection data for selecting first mode and second mode. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 sequentially outputs pulses of the gate signals to the gate lines 103 under the control of the timing controller 130. The gate driver 120 may sequentially supply the gate signals to the gate lines 103 by shifting the pulses of the gate signals using shift registers. When a plurality of gate signals are applied to each pixel, the gate driver 120 may include a plurality of shift registers. The gate signal may include a scan signal being input to the pixel circuit through a plurality of gate lines, and an emission signal (or EM signal).

The timing controller 130 receives digital video data of an input image and a timing signal synchronized with this data from the host system 300. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The host system 300 may include a main board of one of a television system, a set-top box, a navigation system, a personal computer (PC), a vehicle system, a mobile terminal, and a wearable terminal. The host system 300 may scale an image signal from a video source according to the resolution of the display panel 100, and may transmit it to the timing controller 130 together with the timing signals.

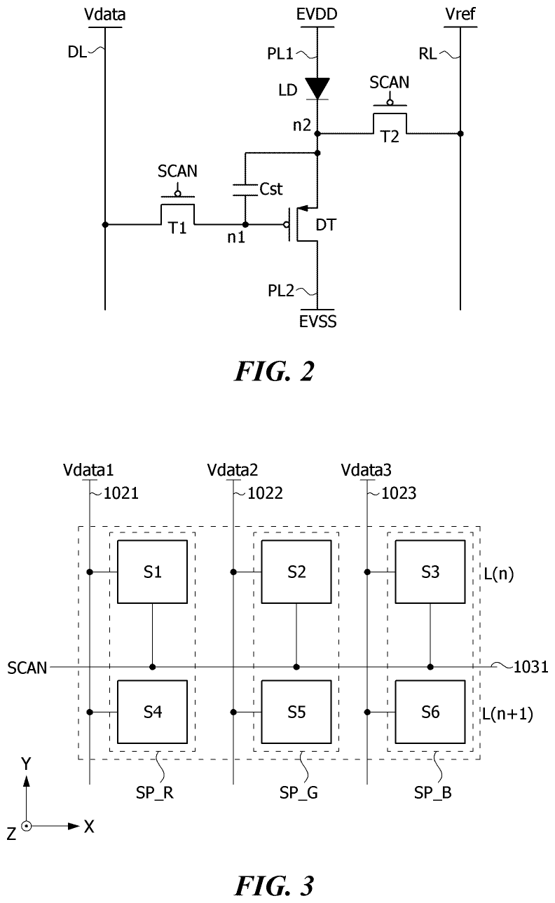

FIG. 2 is a diagram illustrating a pixel circuit according to an embodiment of the present disclosure.

Referring to FIG. 2, a pixel circuit according to an embodiment of the present disclosure includes a light-emitting element LD, a driving element DT that supplies a current to the light-emitting element LD, a plurality of switch elements T1 and T2 that switch a current path connected to the driving element DT, and a capacitor Cst. The driving element DT and the switch elements T1 and T2 may be implemented as p-channel transistors, but are not limited thereto.

The light-emitting element LD may include an anode electrode, a cathode electrode, and an emission layer. The cathode electrode of the light-emitting element LD may be connected to a first power line PL1 to which a pixel driving voltage EVDD is applied. The anode electrode of the light-emitting element LD may be connected to the driving element DT. The light-emitting element LD may be a light-emitting element such as an OLED, mini-LED, or micro-LED, but is not limited thereto. In the case of a mini-LED or micro-LED, the light-emitting element LD may have a vertical structure in which electrodes are arranged on the upper and lower parts of a semiconductor chip in which the light-emitting element LD is integrated, but is not limited thereto. The semiconductor chip in which the light-emitting element LD is integrated may be implemented in a lateral structure or a flip chip structure.

The driving element DT may be turned on by a voltage of a first node n1 to drive the light-emitting element LD. The driving element DT includes a gate electrode connected to the first node n1, a first electrode connected to a second node n2, and a second electrode connected to a second power line PL2 to which a pixel base voltage is applied.

A first switch element T1 supplies a data voltage Vdata to a gate electrode of the driving element DT in response to a scan signal SCAN(N). The first switch element T1 includes a gate electrode to which the scan signal SCAN(N) is applied, a first electrode connected to a data line DL to which the data voltage is applied, and a second electrode connected to the first node n1.

A second switch element T2 applies a reference voltage Vref to the second node n2 in response to a scan signal SCAN(N). The second switch element T2 includes a gate electrode to which the scan signal SCAN(N) is applied, a first electrode connected to the second node n2, and a second electrode connected to a reference voltage line RL to which the reference voltage Vref is applied. In addition, the second switch element T2 may be implemented as a dual transistor including two transistors connected in series, but is not limited thereto.

The capacitor Cst is connected between the first node n1 and the second node n2. The capacitor Cst includes a first electrode connected to the first node n1 and a second electrode connected to the second node n2.

The pixel circuit described herein is merely an example and is not necessarily limited thereto.

FIG. 3 is a diagram illustrating a unit pixel structure according to an embodiment of the present disclosure.

Referring to FIG. 3, the pixels 101 may include two sub-pixels for each color. Each of the pixels 101 includes first-first and first-second sub-pixels S1 and S4 which are adjacent in a second direction (Y direction) parallel to the data lines 102 and in which pixel data of first color is written, second-first and second-second sub-pixels S2 and S5 which are adjacent in the second direction (Y direction) and in which pixel data of second color is written, and third-first and third-second sub-pixels S3 and S6 which are adjacent in the second direction (Y direction) and in which pixel data of third color is written. The first color may be red, the second color may be green, and the third color may be blue, but are not limited thereto. For example, the first-first and first-second sub-pixels S1 and S4 may be red sub-pixels SP_R to which a data voltage of red data is applied. The second-first and second-second sub-pixels S2 and S5 may be green sub-pixels SP_G to which a data voltage of the green data is applied. The third-first and third-second sub-pixels S3 and S6 may be blue sub-pixels SP_B to which a data voltage of the blue data is applied.

The first-first, second-first, and third-first sub-pixels S1, S2, and S3 may be interpreted as main sub-pixels. The first-second, second-second, and third-second sub-pixels S2 and S5, and S6 may be interpreted as redundancy or auxiliary sub-pixels.

In such case, the data lines connected to sub-pixels of the same color may be separated. For example, the first-first and first-second sub-pixels S1 and S4 may be commonly connected to one data line 1021, the second-first and second-second sub-pixels S2 and S5 may be commonly connected to one data line 1022, and the third-first and third-second sub-pixels S3 and S6 may be commonly connected to one data line 1023.

Further, the gate lines connected to the sub-pixels of each pixel line may be shared. For example, the first-first and first-second sub-pixels S1 and S4, the second-first and second-second sub-pixels S2 and S5, and the third-first and third-second sub-pixels S3 and S6 may share a gate line 1031 to which a scan signal SCAN is applied.

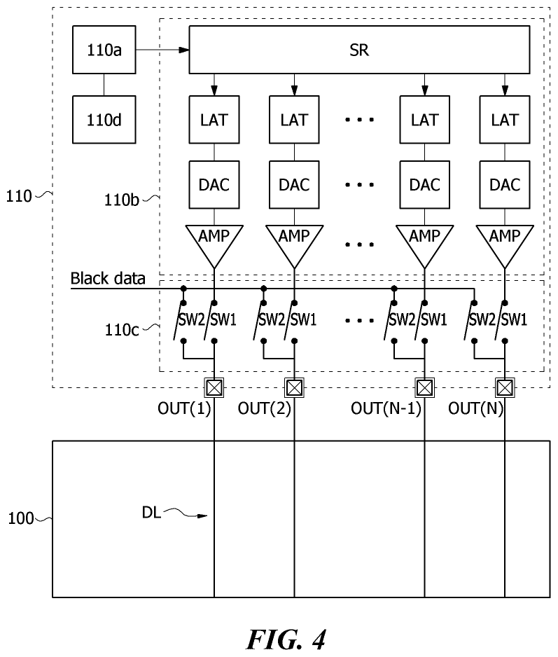

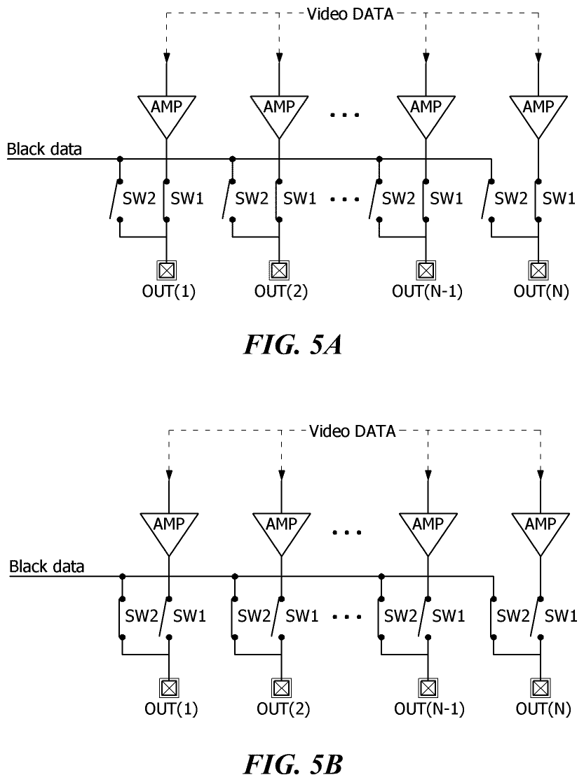

FIG. 4 is a diagram illustrating the configuration of the data driver according to an embodiment of the present disclosure, and FIGS. 5A to 5C, FIGS. 6 to 8, and FIGS. 9A and 9B are drawings for explaining the data voltage output principle.

Referring to FIG. 4, the data driver according to an embodiment of the present disclosure may comprise a control circuit 110a, an output circuit 110b, a selection circuit 110c, and a memory 110d.

The control circuit 110a may receive a pixel data and a data timing control signal from a timing controller, transmit the pixel data to the output circuit 110b based on the received data timing control signal, and control the selection circuit 110c to control that an image data voltage or a black data voltage is output to the corresponding data line DL via the output channels OUT(1), OUT(2), . . . , OUT(N-1), and OUT(N).

For example, in the case of duty driving, the control circuit 110a may control the selection circuit 110c to alternately output the image data voltage or the black data voltage.

In the case of non-duty driving, the control circuit 110a may copy the pixel data corresponding to the image data voltage output to the data line and store it in the memory 110d, and may output the same image data voltage to the output circuit 110b using the stored pixel data so as to replace the black data voltage at the timing when the black data voltage would be output.

The voltage output circuit 110b may include a shift register SR, a latch LAT, a digital-to-analog converter DAC, and an amplifier AMP.

The shift register SR may shift a clock input from the timing controller to generate a sampling clock, and may sequentially output the generated sampling clock to the latches LAT.

The latches LAT may sample and store pixel data of the input image according to the timing of the sequentially input sampling clock, and may simultaneously output the stored pixel data.

The DA converters DAC may convert the pixel data output from the latches LAT using gamma compensation voltages for each grayscale into an analog form.

The amplifier AMP may amplify the voltage level of the pixel data in analog form, and may output the pixel data with the amplified voltage level to the corresponding data lines through the output terminals.

The selection circuit 110c may include a plurality of first switches SW1 and a plurality of second switches SW2. The plurality of first switches SW1 may output the image data voltage output from the output circuit 110b to the data line corresponding to the output channel. The plurality of second switches SW2 may output the black data voltage to the data line to the corresponding data line for each output channel.

In such case, the black data voltage may be supplied from the power supply, but is not limited to thereto.

Each of the plurality of first switches SW1 is connected between the output end of the amplifier AMP in the output circuit 110b and the data line, and when it is turned on by control of the control circuit 110a, the image data voltage may be output to the data line. During this period, the plurality of second switches SW2 are turned off.

Each of the plurality of second switches SW2 is connected between the wire to which the black data voltage is applied and the data line, and when it is turned on by control of the control circuit 110a, the black data voltage may be output to the data line. During this period, the plurality of first switches SW1 are turned off.

In the embodiment according to the present disclosure, as shown in FIG. 5A to FIG. 5C, it is intended to alternately output image data voltage D1, . . . , D6 and a black data voltage B to the data line through the selection circuit 110c at different timings at predetermined time interval. Here, the predetermined time interval represents a emission time of the light-emitting element, which may be n×H (n is a natural number).

The benefits of the duty driving method according to the embodiment of the present disclosure compared to the comparative example are described below.

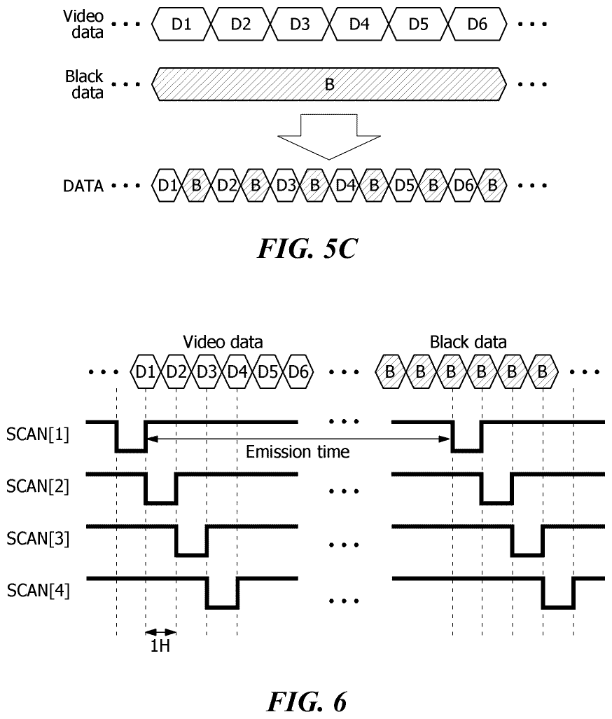

The duty driving method of the comparative example, as shown in FIG. 6, sequentially applies the image data voltages D1, . . . , D6 and then sequentially apply the black data voltage through all scan lines, during one frame period.

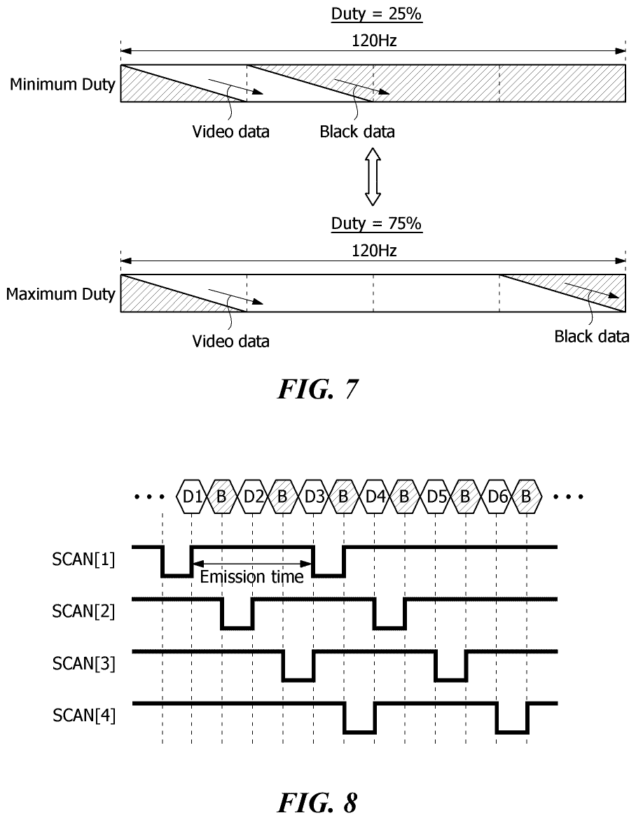

In the case of the duty driving method of this comparative example, the duty rate may be adjusted within the range of 25% to 75% as shown in FIG. 7, but it is impossible to adjust below 25% because the black data voltage is applied after the image data voltages are applied to all scan lines.

The duty driving method according to the embodiment of the present disclosure applies the image data voltages D1, . . . , D6 for each scan line and then applies a black data voltage B after a predetermined time interval or an emission time, as shown in FIG. 8.

The image data voltages D1, . . . , D6 are applied in synchronization with the first output timing of the scan signal output through each scan line, and the black data voltage B is applied in synchronization with the second output timing of the scan signal.

For example, the image data voltage D1 is applied in synchronization with the first output timing of a first scan signal SCANN[1], and the black data voltage B is applied in synchronization with the second output timing thereof. The image data voltage D2 is applied in synchronization with the first output timing of a second scan signal SCANN[2], and the black data voltage B is applied in synchronization with the second output timing thereof. In this way, the image data voltages D1, . . . , D6 and the black data voltage B may be alternately applied at predetermined time interval.

As such, in this embodiment according to the present disclosure, since the image data voltage and the black data voltage may be temporally separated and alternately applied, so that the black data voltage may be freely applied until the last scan signal for applying the image data voltage is output.

In this case, the output timings of the neighboring scan signals, such as the output timings of the (n)th scan signal and the output timing of the (n+1)th scan signal, are separated by a time interval of one horizontal period (1H), but not limited thereto.

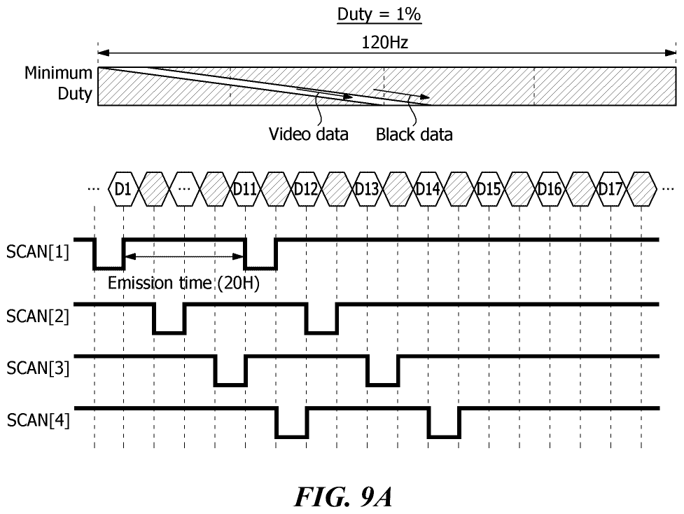

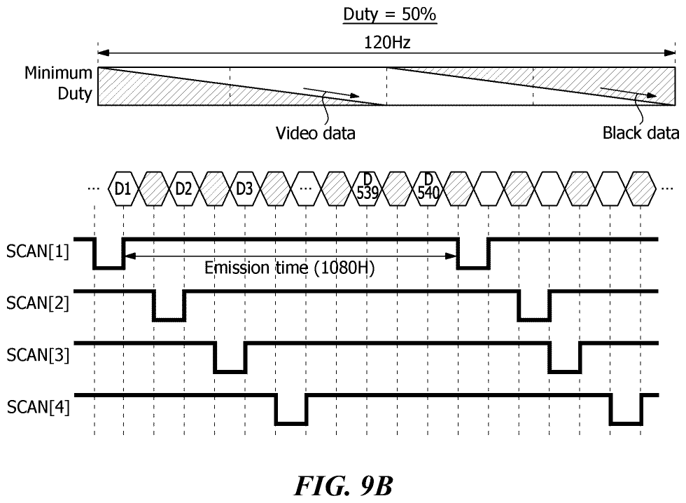

When applying the duty driving method according to this embodiment of the present disclosure, as shown in FIGS. 9A and 9B, the duty rate may be adjusted within a range of 1% to 50%, inclusive, so it may be possible to adjust the duty rate below the duty rate of 25% achieved in the duty driving method of the comparative example.

For example, as shown in FIG. 9A, if the vertical resolution is 510×4=2160 H and the light-emitting element has a emission time of 20 H, the duty rate may be 20/2160×100≈1%.

As another example, as shown in FIG. 9B, if the vertical resolution is 510×4=2160 H and the light-emitting element has a emission time of 1080 H, the duty rate may be a maximum duty rate of 1080/2160×100≈50%.

When applying the driving method according to this embodiment of the present disclosure, the duty rate may be adjusted depending on the emission time of the light-emitting element. For instance, as the emission time of the light-emitting element decreases, the duty rate becomes smaller, and conversely, as the emission time increases, the duty rate becomes larger.

Furthermore, in this embodiment according to the present disclosure, the duty rate may be set differently depending on the emission efficiency of the light-emitting element for each color.

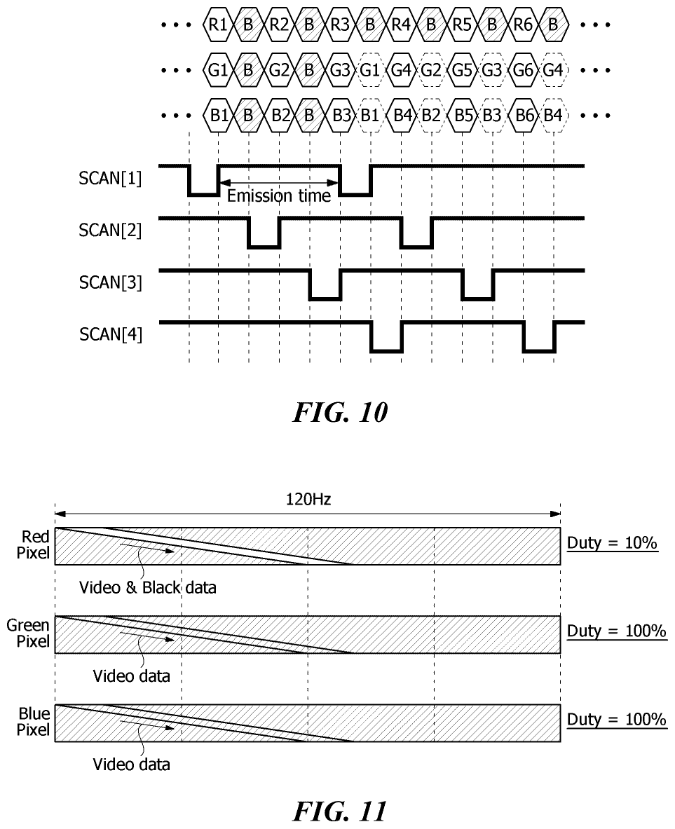

FIGS. 10 and 11 are drawings for explaining the data output principle according to the second embodiment of the present disclosure.

Referring to FIGS. 10 and 11, the light-emitting elements of the red pixels with the largest variation in emission efficiency may be duty-driven, while the light-emitting elements of the remaining green and blue pixels may not be duty-driven.

The reason is that, for light-emitting elements with small changes in emission efficiency, driving them with a lower duty rate has little effect on reducing power consumption, but increases the peak current.

For example, in the case of red pixels, image data voltages R1, . . . , R6 are applied at the first output timing of the scan signal output to each scan line, and then a black data voltage B is applied at the second output timing after a predetermined time interval.

In the case of green pixels, image data voltages G1, . . . , G6 are applied at the first output timing of the scan signal output to each scan line, and the same image data voltage G1, . . . , G4 as those applied at the first output timing is applied at the second output timing.

In the case of blue pixels, image data voltages B1, . . . , B6 are applied at the first output timing of the scan signal output to each scan line, and the same image data voltage B1, . . . , B4 as those voltage applied at the first output timing is applied at the second output timing.

The data driver may apply an image data voltage at a first output timing of the scan signal output to each scan line for the green and blue pixels, and copy or store the corresponding image data voltage, and then output the stored image data voltage at a second output timing.

Accordingly, the light-emitting elements of the red pixels are driven at 10% duty, while the light-emitting elements of the green and blue pixels are driven at 100% duty, i.e., they are not duty-driven.

In the second embodiment according to the present disclosure, only the light-emitting elements of the red pixels with the largest variation in emission efficiency are duty-driven, thereby not only reducing power consumption but also reducing the magnitude of the peak current.

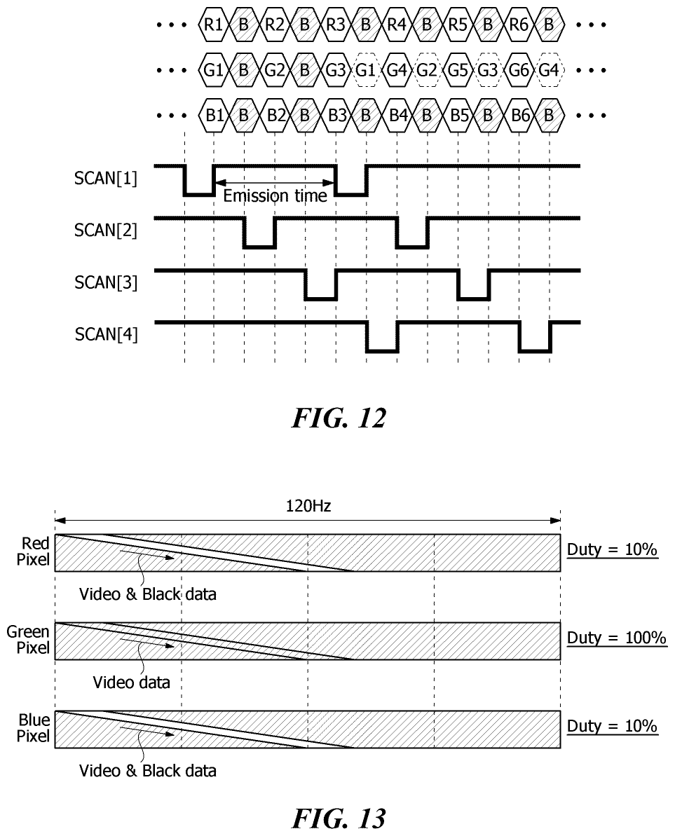

FIGS. 12 and 13 are drawings for explaining the data output principle according to the third embodiment of the present disclosure.

Referring to FIGS. 12 and 13, the light-emitting elements of the red and blue pixels with variation in emission efficiency may be duty-driven, while the light-emitting elements of the remaining green pixels may not be duty-driven.

For example, in the case of red pixels, the image data voltages R1, . . . , R6 are applied at the first output timing of the scan signal output to each scan line, and then a black data voltage B is applied at the second output timing after a predetermined time interval.

In the case of green pixels, the image data voltages G1, . . . , G6 are applied at the first output timing of the scan signal output to each scan line, and the same image data voltage G1, . . . , G6 as the image data voltage applied at the first output timing is applied at the second output timing.

In the case of blue pixels, the image data voltages B1, . . . , B6 are applied at the first output timing of the scan signal output to each scan line, and then the black data voltage B is applied at the second output timing after a predetermined time interval.

Accordingly, the light-emitting elements of the red and blue pixels are driven at 10% duty, while the light-emitting elements of the green pixels are driven at 100% duty, i.e., they are not duty-driven.

In the third embodiment according to the present disclosure, only the light-emitting elements of the red and blue pixels with variation in emission efficiency are duty-driven, thereby not only reducing power consumption but also reducing the magnitude of the peak current.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A data driver comprising:
an output circuit configured to output a pixel data as an image data voltage in analog form;
a selection circuit configured to connect one of an output end of the output circuit or a wire for transmitting a black data voltage to a data line; and
a control circuit configured to control the selection circuit so that the image data voltage and the black data voltage are alternately output at a time interval.

2. The data driver according to claim 1, wherein the control circuit is configured to control the selection circuit such that, during each frame period, the image data voltage is output at the first output timing of a gate signal and the black data voltage is output at the second output timing elapsed by the predetermined time interval from the first output timing.

3. The data driver according to claim 2, wherein the time interval is set to n×horizontal period, where n is a natural number.

4. The data driver according to claim 2, wherein the control circuit is configured to control the selection circuit such that, for a red sub-pixel, the red image data voltage is output at the first output timing and the black data voltage is output at the second output timing.

5. The data driver according to claim 4, wherein the control circuit is configured to control the selection circuit such that, for a green sub-pixel, a green image data voltage is output at the first output timing and the same image data voltage as the green image data voltage is output at the second output timing.

6. The data driver according to claim 5, wherein the control circuit is configured to control the selection circuit such that, for a blue sub-pixel, a blue image data voltage is output at the first output timing and the same image data voltage as the blue image data voltage is output at the second output timing.

7. The data driver according to claim 6, further comprising:
a memory in which pixel data corresponding to the green image data voltage and the blue image data voltage that are output at the first output timing are stored.

8. The data driver according to claim 1, wherein the selection circuit includes:
a plurality of first switches connected between the output end of the output circuit and the data line; and
a plurality of second switches connected between the wire and the data line.

9. A display device comprising:
a pixel array in which a plurality of data lines, a plurality of gate lines, and a plurality of pixels are arranged;
a data driver configured to output a data voltage to the plurality of data lines; and
a gate driver configured to output a gate signal to the plurality of gate lines;
wherein the data driver comprises:
an output circuit configured to output a pixel data as an image data voltage in analog form;
a selection circuit configured to connect one of an output end of the output circuit or a wire for transmitting a black data voltage to a data line; and
a control circuit configured to control the selection circuit so that the image data voltage and the black data voltage are alternately output at a predetermined time interval.

10. The display device according to claim 9, wherein the control circuit is configured to control the selection circuit such that, during each frame period, the image data voltage is output at the first output timing of a gate signal and the black data voltage is output at the second output timing elapsed by the predetermined time interval from the first output timing.

11. The display device according to claim 10, wherein each of the plurality of pixels includes a red sub-pixel, a green sub-pixel, and a blue sub-pixel, and
the control circuit is configured to control the selection circuit such that, when the image data voltage is output to a red sub-pixel, a red image data voltage is output at the first output timing and the black data voltage is output at the second output timing.

12. The display device according to claim 11, wherein the control circuit is configured to control the selection circuit such that, when the image data voltage is output to a green sub-pixel, a green image data voltage is output at the first output timing and the same image data voltage as the green image data voltage is output at the second output timing.

13. The display device according to claim 12, wherein the control circuit is configured to control the selection circuit such that, when the image data voltage is output to a blue sub-pixel, a blue image data voltage is output at the first output timing and the same image data voltage as the blue image data voltage is output at the second output timing.

14. The display device according to claim 13, wherein the data driver further comprises:
a memory in which pixel data corresponding to the green image data voltage and the blue image data voltage that are output at the first output timing are stored.

15. The display device according to claim 11, wherein the red sub-pixel, the green sub-pixel, and the blue sub-pixel are commonly connected to one gate line, and are respectively connected to different data lines.
